(19) United States
(12) Patent Application Publication
(10) Pub. No.: US 2005/0284202 A1
(43) Pub. Date: Dec. 29, 2005

(54) Plant growth medium

(76) Inventors: Lea Rampton, Maryborough (AU); Mervyn Connick, Maryborough (AU)

Correspondence Address: DUANE MORRIS LLP;IP DEPARTMENT, 30 SOUTH 17TH STREET, PHILADELPHIA, PA, 19103-4196, US

(21) Appl. No.: 10/521,870

(22) PCT Filed: Jul. 22, 2003
(86) PCT No.: PCT/AU03/00930

§ 371 Date: Jan. 21, 2005

(30) Foreign Application Priority Data
Jul. 22, 2002 (AU) 2002950316

(51) Int. Cl. C05G 3/02

(52) U.S. Cl. 71/23; 504/101

(57) ABSTRACT

An organic potting mix is produced from sawmill wastes comprising predominantly wastes from the pinus genus either alone or mixed with other organic waste materials by a continuous process wherein the sawmill waste feedstock is comminuted, submerged in heated water containing treatment chemicals and then at least partially dewatered to a moisture content of from 15%-25% ww and a moisture capacity of about 50% ww. The potting mix so produced may be subjected to further comminution in an apparatus which applies mechanical shear under pressure to produce a peat moss alternative having an enhanced moisture capacity up to about 80% ww. An apparatus for the continuous production of the potting mix comprises a screw auger located in an inclined tubular body wherein the sawmill waste feedstock is submerged during travel from a lower end to an elevated dewatering end of said tubular body.

### FIELD OF THE INVENTION

This invention is concerned with a method and apparatus for producing plant growth media using waste materials primarily of vegetable origin.

The invention is concerned, particularly, but not exclusively, with the manufacture of plant growth media from sawmill waste, with or without other organic waste materials.

### BACKGROUND OF THE INVENTION

As the population increases, particularly in developed countries, so has the interest in growing plants, both indoors and outdoors. With this increased interest in plant growing there has also occurred a substantial growth in the size and number of commercial and retail plant nurseries and this in turn has led to a large demand for plant growth media such as potting mixes, orchid mixes, bulb mixes, hanging basket mixes and seedling propagation mixes many of which are classified as regular or premium grades.

Due to the wide range of materials being sold as plant growth media, it has been recognized that some materials are unsatisfactory for their intended use and indeed, some materials present a significant health hazard both to plants and humans. Of relatively recent times, cases of Legionnaires Disease in gardeners have been linked to handling of contaminated plant growth media and with more efficient national and international transportation systems there exists a significant risk of distributing over a wide geographical area insect pests, wild yeasts and other micro-organisms and pathogens harmful to both animals and plants. Moreover, such plant growth media could form an effective vector for distributing seeds of undesirable species throughout regions otherwise free of such plant pests.

In order to establish a set of requirements for manufacturers which will ensure that potting mixes and the like can be relied upon by scientific institutions, consumers and commercial growers to germinate seeds, grow seedlings, strike cuttings and maintain plant growth, Australian Standard AS 3743-Potting Mixes was established in 1996. This Standard also establishes requirements including a health warning label and hazardous information label for customers in the handling of potting mixes. A key requirement of the Standard is that “the mix should also be free of plant pathogens, other pests, harmful chemical substances and any parts of plants generally considered to be weeds”.

It is known to use sawmill waste in the manufacture of plant growth media but this can be quite problematic particularly in the case of conifer species because of a low pH arising from tannins or phenolic materials therein. A low pH environment in a plant growth medium can kill many plant species or at least retard plant growth.

It is widely known to produce plant growth media by mulching materials such as sawmill waste alone or mixed with other materials by forming covered heaps and allowing natural fermentation to cause a temperature rise within the heap to kill at least some of the micro-organisms, plant pathogens and insect pests which may be contained therein. A serious disadvantage of this process is that the temperature distribution in a covered heap is not uniform and thus not all micro-organisms and plant pathogens are killed in this process and indeed human pathogens eg. Legionnaires Disease can be transmitted to humans from these mulched materials of vegetable origin. Probably the greatest disadvantage however with naturally fermented mulching processes is that it takes from two to three months or even longer for the fermentation or mulching cycle to be completed, and very large storage areas are required to build the heaps or windrows in which the fermentation process occurs.

European Patent No 0360447 describes a process for treatment of comminuted bark in sealed bags by microwave radiation to kill insect pests, yeasts and other micro-organisms but does not address the problem associated with low pH in the resultant medium. This process is both energy and capital intensive.

Australian Patent No 520873 describes the treatment of fresh green bark particles containing sap from which at least some phenolic materials are removed by treatment with an aqueous alkaline material such as sodium sulphite, sodium bisulphite, sodium metabisulphite, sulphur dioxide, ammonium sulphates, sodium carbonate, sodium bicarbonate, potassium bicarbonate, sodium hydroxide, potassium hydroxide, ammonium hydroxide, ammonium carbonate and/or ammonia. After extraction of phenolic materials, conditioning materials such as vermiculite and expanded perlite are added to the treated bark particles and, if required, fertilising materials may also be added to contribute nitrogen, phosphorous and potassium. The process described is a counter-current flow process wherein the spent liquor is extracted to reclaim phenolic materials used together with formaldehyde or the like as bonding agents in particleboard or the like. The process is carried out at a temperature above ambient and requires the processing time of about two hours to remove the phenolic materials to the desired degree.

European Patent Application 014355 describes a composted plant growth medium wherein comminuted bark is treated with super heated steam and aqueous ammonium or nitrate solutions to provide a soluble nitrogen source. The product so produced has a moisture content of 60-70 weight percent which is then fermented at a pH of 6 to 7.5 for three months. Phosphorus and potassium compounds can be added if necessary to obtain the desired end PK ratio.

Canadian Patent No 1203991 describes a process wherein comminuted bark is sterilised in air at 300-700° C., further comminuted and then is treated with a solution of calcium chloride, then a solution of soluble sodium or potassium silicate at a pH of 6 to 7. The resultant product is described as an inert soil conditioner to improve plant growth qualities in clay soils and prevent shrinkage and cracking.

German Patent Application 33344540 describes a soil conditioner made by cleaning, comminuting, heat treating bark particles to 130° C. with subsequent drying at 500 to 550° C. to produce a sterile product with very low moisture content and a very long shelf life even when other plant nutrients are added.

U.S. Pat. No. 4,804,401 describes a complex apparatus and process for producing a soil conditioner with a phosphorous fertilising effect by reacting a phosphate rock with an acidic organic reaction mass to produce a phosphate containing organic medium.

German Patent No 3040040 describes a soil conditioner produced by grinding conifer bark to a fine particle size and then mixing with aqueous ammonium bicarbonate to give a mixture containing from 70 to 80 weight percent of water and then composting the mixture for three months.

Australian Patent Application 50101/90 describes a soil substitute comprising shredded and composted bark mixed with stone, aggregate and siliceous sand particles. The tree bark is ground and screened, mixed with graded aggregate and siliceous sand particles, water and minor minerals such as zeolite, kaolite, bentonite, etc., and trace elements as required. The mixture is then composted in windrows at a temperature of 42 to 60° C. to produce a soil substitute product with a final water content of 40 to 60 weight percent.

Japanese Patent Application 90-118773/16 describes a composite soil conditioner comprising peat bark compost, vermiculite, rigid polyurethane foam granules, cow dung manure, calcine chaff, a slow release composite fertiliser, silica clay, a bacterial inoculant, ammonium nitrate, and calcium superphosphate. This soil conditioner is used to regenerate old growing soils by using a mixture of 1 to 3 to 1 to 4 of the conditioner with the old soil.

International Publication No WO 91/02778 describes a sterile plant growth medium particularly suited to delicate aerophytes such as orchids or the like. The process described comprises a batch process wherein comminuted bark comprising an exogenous portion adhered to an endogenous portion is boiled in the presence of an alkaline material such as powdered limestone, powered dolomite or a mixture thereof to kill heat labile plant pathogens and insect pests and to produce a pH neutral layer on the outside of the bark granules. The heated, chemically treated bark granules are then immersed in water at ambient temperature or lower to cause separation of the endogenous and exogenous portions of the bark and the exogenous portion is collected and dried to form a sterile plant growth medium.

International Publication No WO 95/03371 describes a process for the manufacture of a sterilised peat moss alternative wherein the endogenous bark particles discarded from the process of International Publication No WO 91/02778 referred to above, are subjected to a milling action whilst having a high moisture content between 20% wt to 50% wt or higher. The coarse fibrous material obtained is similar to a coconut fibre or relatively dry peat moss. The fibrous mass produced by the shredding operation is then dried to reduce the moisture content to between 10 to 20% and is compressed and bagged in hermetically sealed plastic bags to maintain moisture content and sterility in the product.

The prior art processes described above all suffer from one or more disadvantages. Composted materials for example, require a high moisture content, typically in the range 50 wt % to 80 wt % to support bacterial and/or enzymatic digestion in an exothermic reaction at temperatures of between 40° and 60 to 80° C. for extended periods of time, typically about three months. Thereafter the product is dried to about 15%-25% moisture before bagging to reduce transportation costs. Other chemically treated materials are typically performed as batch processes which are labour intensive and otherwise generate spent treatment liquors which cannot readily be disposed of without costly extraction or treatment processes to produce an environmentally acceptable waste. The product of these processes is typically very dry with a low moisture content below 15%. Although naturally occurring materials such as peat and sphagnum peat have been popular as plant growth media in the past, supplies of these products are becoming increasingly more scarce to the extent that it has been necessary to import them from overseas countries. The rapidly increasing cost of peat and sphagnum peat as plant growth media has caused the investigation of other organic materials as an alternative or replacement for these compositions.

A major difficulty with all of these prior art plant growth media is that once dried to a moisture content below about 25%, it is very difficult to rehydrate the medium to more than about 50% and thus it may be necessary to go to extraordinary measures to rehydrate say, natural peat, beyond about 50% ww moisture content. The requirement for special equipment and labour intensive processes to rehydrate natural peat is both inconvenient and costly and time consuming.

Accordingly, there is a need for rapid, high volume continuous process for producing a sterile or pest free plant growth medium, which process is both cost effective and is environmentally acceptable and results in a product which is easily rehydrated.

### SUMMARY OF THE INVENTION

According to one aspect of the invention there is provided a method for production of organic plant growth media from sawmill waste, said process comprising the steps of:—
introducing comminuted sawmill waste into an inlet of a conveyor mechanism containing a body of heated water;
submerging said sawmill waste in said body of heated water for a predetermined period of time to kill microorganisms, insects, plant and animal parasites and the like whilst transporting said treated sawmill waste towards an outlet of said conveyor mechanism; and
at least partially dewatering said treated sawmill waste to a predetermined moisture content.

The comminuted sawmill waste may comprise material of sawmill waste including sawdust, bark and woodchips alone or mixed with up to 20% ww of peat, spent mushroom compost, animal or chicken manure, sewerage sludge, waste vegetables or vegetable scraps, meat or bone meal of animal origin or the like or selected combinations thereof.

Preferably said sawmill waste comprises particulate pine bark having a layer of exogenous bark adhering to endogenous bark said method further including the step of at least partially separating said endogenous bark and said exogenous bark.

If required, at least partial separation of said exogenous bark and said endogenous bark may be effected in said conveyor system by the application of mechanical force to said particulate pine bark.

Alternatively, at least partial separation of said exogenous bark and said endogenous bark may be effected during or subsequent to the step of at least partial dewatering of said sawmill waste.

Suitably said body of water is heated to a temperature in the range 85° to 125° C.

Preferably said body of water is heated to a temperature in the range 100° to 110° C.

The sawmill waste suitably is comminuted to a particle size where substantially all the comminuted sawmill waste passes through a 12 mm screen.

If required, the body of water may contain a chemical treatment composition selected from a pH modifier, plant nutrients, pesticides, microbicides, parasiticides, fungicides or the like.

The method may be performed, at least partially, under a pressure greater than ambient air pressure.

The treated sawmill waste may be at least partially dewatered in said conveyor mechanism adjacent an outlet port thereof.

If required, the treated sawmill waste may be at least partially dewatered under the influence of mechanical pressure.

Alternatively, or additionally, the treated sawmill waste may be at least partially dewatered in a rotary dewatering apparatus.

Suitably the treated sawmill waste may be at least partially dewatered under the influence of heat.

The treated sawmill waste may be at least partially dewatered by evaporation at ambient temperature and pressure.

Preferably, at least partially dewatered treated sawmill waste containing at least partially separated exogenous bark and endogenous bark is subjected to mechanical shear under pressure to loosen fibrous bonds in said particulate pine bark to enhance moisture retention therein.

The treated sawmill waste, after at least partial dewatering to a moisture content in the range of from 15% ww to 25% ww is packaged in hermetically sealed containers to maintain a substantially sterile state free from contamination by microorganisms, insects, parasites, plant and animal pathogens and the like.

According to another aspect of the invention there is provided an apparatus for manufacture of organic plant growth media from sawmill waste, said apparatus comprising:—
a conveyor in the form of a screw auger rotatably housed in a tubular body, said conveyor being inclined with an upright inlet port located at a lower end of said tubular body and an outlet port at an upper end of said tubular body;
a drive mechanism for said screw auger;
a heating device to heat a body of water located, in use, in said tubular body; and,
a dewatering station located adjacent said outlet port, said dewatering station, in use, at least partially dewatering treated sawmill waste in said tubular body.

Suitably, said inlet port comprises an upright tubular member in fluid communication with said lower end of said tubular body.

Preferably, said inlet port, in use, is able to accommodate portion of a body of water located within said conveyor with an upper surface of said portion being located above a feed end of said screw auger to form a liquid seal between said inlet port and a bore of said tubular body.

If required, the inlet port may include a feed mechanism to assist in directing buoyant organic media towards said feed end of said screw auger.

The inlet port may include a metering device to meter water into said conveyor.

If required, said heating device may be located adjacent said lower end of said tubular body.

The heating device may be selected from a heat exchanger through which a heated medium is circulated or it may comprise one or more electrical heating elements.

Preferably, said heating device comprises a steam generator fluidically coupled adjacent a lower end of said tubular body.

The dewatering station may comprise a region of tubular body having a plurality of apertures therein through which to drain water from said treated sawmill waste.

Suitably, a collector is associated with said plurality of apertures to collect drained water and return said drained water to said tubular body.

The dewatering station may comprise a region of said screw auger wherein the pitch of said auger is reduced to cause, in use, compression of said treated sawmill waste to assist in dewatering thereof.

Alternatively, the dewatering station may comprise a region of said conveyor where the respective diameters of said screw auger and an adjacent region of said tubular body are reduced to cause, in use, compression of said treated sawmill waste to assist in dewatering thereof.

If required, the dewatering station additionally may comprise a rotatable screen or the like.

If required, said apparatus may include a shredding device to subject fibrous materials in at least partially dewatered organic media to a loosening of fibres in said fibrous materials by the application of mechanical shear under compression.

### BRIEF DESCRIPTION OF THE DRAWINGS

In order that the invention may be more readily understood and put into practical effect, reference will now be made to preferred embodiments described with reference to the accompanying drawings in which:—

FIG. 1 illustrates schematically a side elevation of a treatment apparatus showing certain hidden detail;

FIG. 2 illustrates an enlarged partial view of a modified form of the upper end of the apparatus of FIG. 1 showing hidden detail;

FIG. 3 illustrates a shredding machine for use in accordance with a method according to the invention;

FIG. 4 shows a part cross-sectional view through A-A in FIG. 3; and

FIG. 5 illustrates a flow chart showing the main process steps in producing differing forms of plant growth media according to the invention.

### DETAILED DESCRIPTION OF THE DRAWINGS

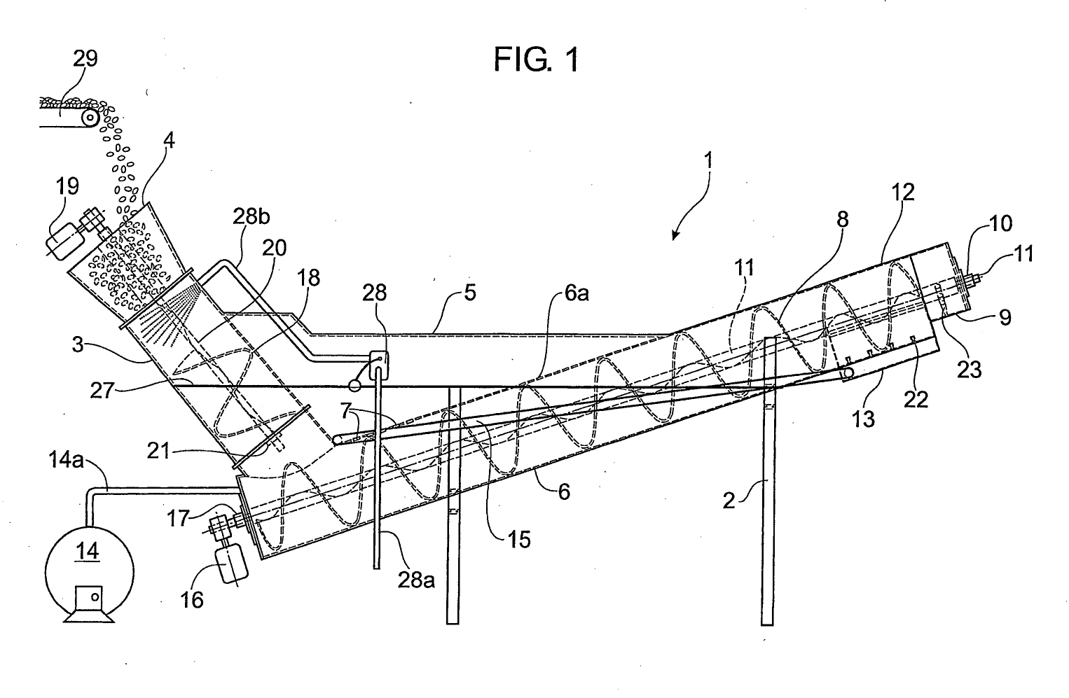

FIG. 1 shows an inclined tubular screw auger conveyor 1 mounted on a support frame 2. Adjacent the lower end of conveyor 1 is an upright tubular inlet port 3 having an open hopper mouth 4 at its upper end. The lower end of inlet port 3 is in fluid communication with the interior of the lower end of conveyor 1.

Mounted on top of conveyor 1 is a liquid holding tank 5 in fluid communication with the interior of tubular body 6 of conveyor 1 via apertures 7 in the upper portion 6a of body 6, which portion 6a forms a floor to tank 5.

At the elevated end of conveyor 1 is an outlet port 9 and a support bracket 10 in which the shaft 11 of a screw auger 8 is rotatably journalled. Just behind outlet port 9 is a collection chamber 13 to collect excess water from dewatering region 12 and return the water so collected to a tank 5 via conduit 15.

Shaft 11 of screw auger 8 extends through a waterproof gland bearing 17 mounted on the lower end of the tubular body 6 of conveyor 1 and is adapted for attachment thereto by a variable speed drive motor/gearbox combination 16. Mounted within inlet port tube 3 is another screw auger 8 driven by another variable speed drive 19 coupled to shaft 20. The lower end of shaft 20 is rotatably journalled in a bracket 21 located within inlet port tube 3.

Formed in the wall of the tubular body of conveyor 1 in the region of collection chamber 13 are slotted apertures 22 through which water drains in the dewatering region 12. To assist in dewatering of comminuted organic material in this region, the mass of treated material being conveyed by auger 8 is subjected to mechanical compression under the influence of gravity and/or back pressure from a restricted outlet port 9 compared with the cross-sectional area of body 6. Mounted on shaft 11 for rotation therewith is a wiping blade 23 to assist in egress of the dewatered mass via outlet port 9 by preventing compaction in the mass of dewatered material.

Located adjacent the lower end of conveyor 1 is a steam generating boiler 14 in fluid communication with the interior of the tubular body 6 of conveyor 1 to deliver steam or superheated steam thereto.

A normal water level designated at 27 is maintained within conveyor 1 by a float valve or the like 28 coupled to a source of pressurized water via conduit 28a. Float valve 28 is coupled via conduit 28b to an upper region of inlet port tube 3 adjacent hopper mouth 4 which receives sawmill waste feedstock via conveyor 29.

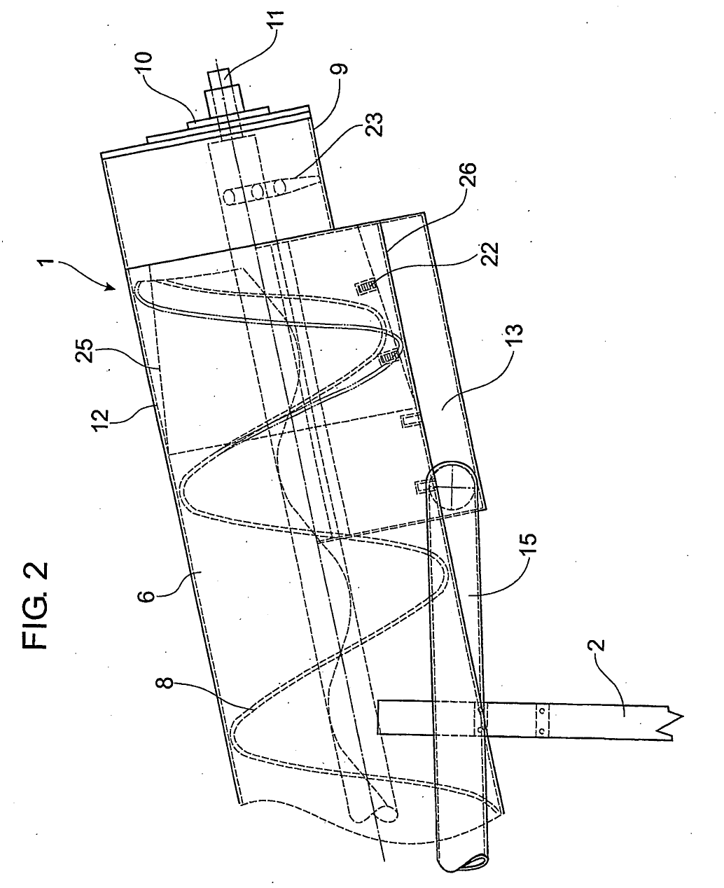

FIG. 2 illustrates an enlarged partial view of the end of the conveyor 1 of FIG. 1 and illustrates hidden detail of modified forms of the apparatus of FIG. 1. For the sake of simplicity, like reference numerals are employed for like features.

In FIG. 2, portion 25 of body 6 in the dewatering station 12 is formed in a convergent frusto-conical taper and the diameter of screw auger 8 is also reduced in this region to impose a degree of mechanical compression to the treated material to assist in dewatering thereof. Alternatively, the pitch of the screw auger may be reduced in the region of dewatering station 12 either in the tapered portion 25 as shown or in a non-tapered portion 26 as shown in phantom. Either the tapered body portion 25 or the reduced pitch screw auger alone or in combination will serve to apply a mechanical compression to treated material in the dewatering station to assist in the dewatering thereof.

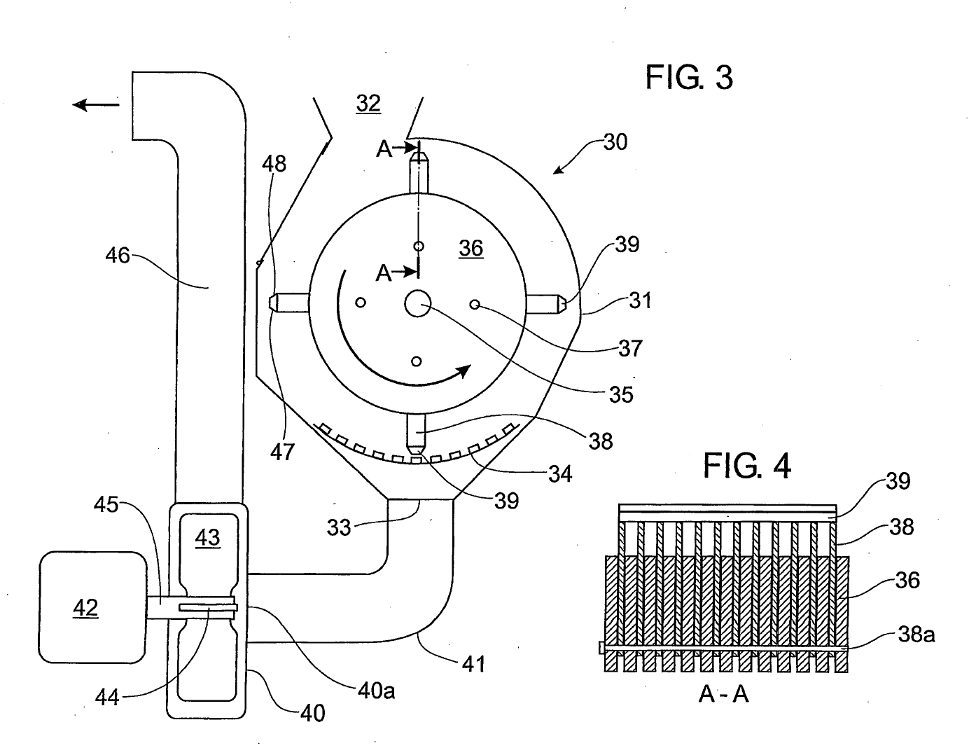

FIG. 3 illustrates a shredding apparatus according to the invention.

Shredder 30 constitutes a modified form of hammer mill having a housing 31 with an inlet port 32 and an outlet port 33 located below a perforated screen 34. Mounted on a rotatable shaft 35 are a series of spaced discs 36 having aligned apertures 37 to pivotally support a series of spaced hammers 38 between respective adjacent discs 36 on a mounting bar 38a extending through aligned apertures 37. A cross-sectional view through A-A shown in FIG. 4 shows a shredder bar 39 secured across the outer ends of hammers 38.

A conveyor 40 in the form of a modified centrifugal pump has an inlet port 40a in communication with the outlet port 33 of shredder 30 via a conduit 41. Conveyor 40 is powered by a drive motor 42 having a plurality of spaced radially extending blades 43 pivotally mounted on a boss 44 secured to a drive shaft 45 of motor 42 instead of the conventional curved volute impeller normally associated with such centrifugal pumps. A tangentially directed outlet port (not shown) of conveyor 40 is coupled to a conduit 46 for delivery of shredded material to a storage area (not shown). Shredder bar 39 has a tapered leading edge 47 and a tapered trailing edge 48 to enable reversal of the shredder bar 39 after the leading edge has worn.

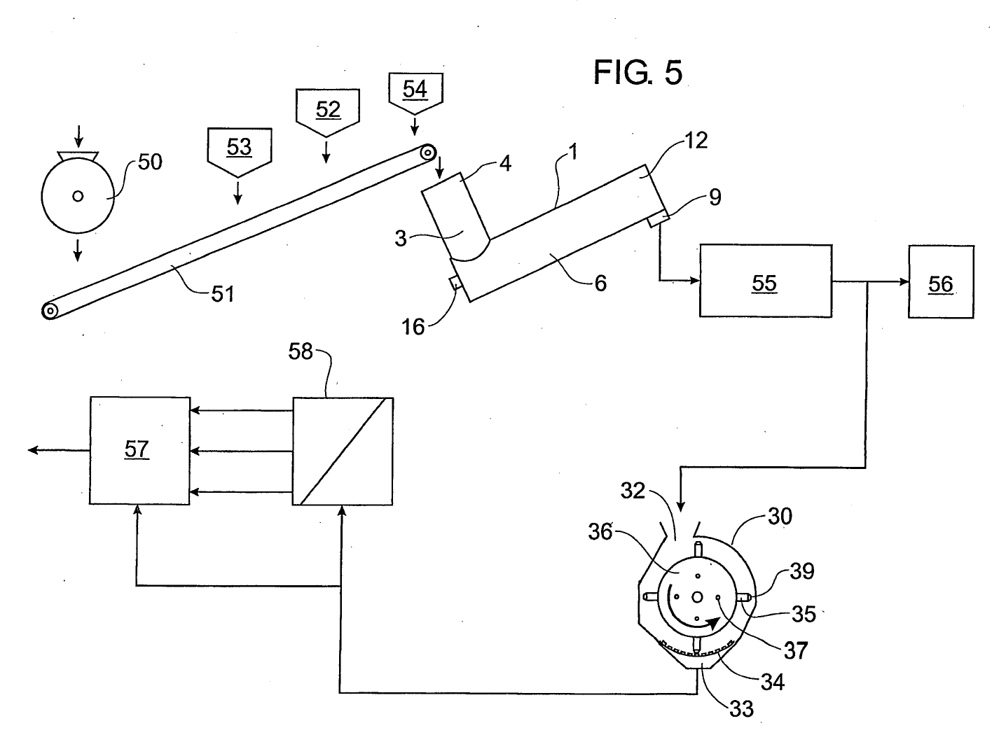

Although the apparatus and method of the invention may be employed to treat and/or sterilize a variety of comminuted organic materials a method now will be described for the manufacture of sterilized plant growing media utilizing sawmill waste as a feedstock, the method being illustrated schematically in FIG. 5.

FIG. 5 shows schematically the manufacturing process according to the invention and for the sake of simplicity like reference numerals are employed for like features illustrated in FIGS. 1-4.

Referring now to FIGS. 1-5, sawmill waste is processed by a hammermill 50 or the like to reduce the waste to a size where substantially all of the milled waste will pass through a 20 mm screen. Typically, of the particulate material so produced, about 15% is retained on a 12 mm screen and about 75% is retained on an 8 mm screen.

Initially, the water in tubular conveyor body 6 is heated to boiling by introducing steam via conduit 14a into the interior of body 6 below waterline level 27. Because of the head of water (between 2 to 3 metres) in conveyor tube 18, a temperature of between 105° and 110° C. can be maintained in the body of water in conveyor 1. The level of water is maintained in the apparatus by metering make up water into body 6 via inlet port 3 to compensate for losses in the treated sawmill waste issuing from the outlet port 9.

Sawmill waste is predominantly bark having an exogenous layer adhering to an endogenous sapwood layer together with varying quantities of sawdust and timber chips. Because the bark portion of sawmill waste, and particularly, in respect of coniferous barks, is quite acid due to a high level of phenolic compounds (tannins) it is desirable to partially neutralize these surface tannins as many plants are sensitive to excessively acid or alkaline growing media. Milled sawmill waste is conveyed to feed hopper 4 by a conveyor 51 and dolomite or lime in a powdered form is added by a metering feeder 52 at a rate of about 25 kg per 10 cubic metres of radiata pine bark. This will produce a treated plant growth medium having a surface pH in the range of 5.8 to 6.5 to meet AS 3743-1996 requirements, although it is preferred to maintain pH in the range 6.2 to 6.4 for the sake of product consistency. Plant nutrients containing nitrogen, phosphorus and potassium compounds, minerals and trace elements may also be added in a liquid, slurry or dry powder form by a suitable metering means 53. If required, a colorant dispenser 54 may meter a colorant into the feedstock, the purpose of the colorant being described later.

Milled and screened sawmill waste with appropriate additives is then added to the inlet hopper mouth 4 and because the particulate sawmill waste is very buoyant, screw auger 8 is necessary to urge the particulate feed below the water level in inlet port 3 and into the region of screw auger 8

With screw auger 8 rotating at a speed sufficient to give a submerged residence time of from 15 to 20 minutes the particulate mass is transported below the level 27 of water in the tubular body of conveyor 1 towards outlet nozzle 9. As the mass of treated sawmill waste emerges from below the water level in conveyor 1, it passes through dewatering region 12 wherein the combined effects of friction between adjacent particles causing a tumbling effect and compression in the tubular body cause excess water on the surface of the particulate material to flow under the influence of gravity via apertures 22 for collection in collection chamber 13 shown in FIGS. 1 and 2. Excess water so collected then drains back directly into the tubular body of conveyor 1 at a suitable position. It can be seen that with the apparatus, the continuous treatment process does not pose an environmental threat with disposal of spent treatment water containing treatment chemicals otherwise being allowed to enter a stormwater drain or the like.

The dewatering process may be assisted by compressing the mass of particulate material in the dewatering region 12. This may be effected by altering the size of outlet port 9 to give rise to a back pressure in the screw auger 18. Wiper blade 23 is effective to prevent blockage of outlet port 9 due to compaction of particulate material by loosening the “plug” of compacted material above port 9 as it rotates with the shaft 11 of screw auger 8.

Particulate plant growth medium issuing from nozzle 9 typically has a moisture content of about 30 to 35% ww. For prolonged shelf life of packaged product it is desirable that the moisture content be retained above about 10% but below about 25% ww, preferably in the range of from 15 to 23% ww, most preferably in the range from 18% to 20% ww.

The optimum moisture content may be obtained by passing the particulate product through a rotating drain drier 55 such as a trommel screen heated with steam or hot air. Alternatively, it may be spread out on a covered storage surface for a day or so depending upon prevailing weather conditions to enable evaporation of excess water.

It is important however, that the product is not allowed to dry out to a moisture content less than about 10% as it is very difficult to rehydrate for use. At the same time, if the product is allowed to dry naturally, it should not be left exposed for any more than about two days due to the risk of reinfection from airborne bacteria, viruses and fungal spores or from regrowth of remnants of microbial populations remaining after the treatment.

The regular grade general purpose potting mix so produced has a particle size range wherein about 15% ww is retained on a 12 mm screen and about 75% ww is retained on an 8 mm screen. This product is then transferred to shipping station 56 for shipping in bulk transport vehicles or is bagged in sealed plastic bags with a typical moisture content of about 18 to 20% ww and this permits a shelf life of a substantially sterile potting mix of many months.

Some or all of the partially dried regular potting mix product may be further processed to produce a peat alternative which far exceeds the requirements for a premium grade potting mix as specified in AS 3743-1996. As illustrated in FIG. 5, the partially dried regular potting mix emanating from dryer 55 with a moisture content in the range of from 20% to 25% ww is transferred to shredder 30 shown in greater detail in FIGS. 3 and 4.

Unlike a conventional hammer mill which cuts or fractures particulate bark to reduce the particle size, the shredder 30 according to another aspect of the invention forces the bark particles through an 8 mm screen in a “smearing” action due to the tapered leading edge 47 of shredder bar 39. This produces a particulate product comprising predominantly a mixture of separated exogenous and endogenous bark portions having a particle size range wherein from about 15%-20% ww is retained on a 4 mm screen, from about 50%-60% ww on a 3 m screen and from about 10%-25% ww being retained on a 2 mm screen.

After the shredding process, the shredded peat alternative product may be packaged at package station 57 for shipping with a moisture content in the range of from 18%-20% or it may be further separated in a sizing or classification station 58 to produce a premium grade peat alternative in a variety of particle size ranges such as medium, fine and superfine grades. Classification may be effected by screens or with the apparatus of FIG. 3. By maintaining a fairly close control on moisture content of the shredded particles the “blower” conveyor 39 is directed across, say, three storage pens with the larger particles accumulating in the nearest pen, medium sized particles in the middle pen and the finer particles accumulating in the pen farthest from conveyor 40.

With the growing scarcity and increased cost of portable water, commercial plant growers and retail plant nurseries are particularly sensitive to wettability and water holding capacity of plant growth media as these properties can impact significantly on the economics of their businesses.

Appendix C of Australia Standard AS 3743-1996 sets out a method for the determination of “wettability” or the rate of rehydration of dried plant growth media. After drying the medium to a constant mass at 40°±2° C., the medium is placed into vessels and a measured quantity of water is added to a depression in the medium. “Wettability” is measured by the time taken to absorb the added water. Table 21 of AS 3743-1996 requires an absorption rate of ≦5 minutes for regular media and ≦2 minutes for premium grade media.

Appendix B of Australian Standard AS 3743-1996 sets out a method for determining “total water holding capacity” wherein a known volume of medium is immersed in water for a specified time and then removed, drained and weighed. The drained medium is then dried at between 100° C. and 105° C. to a constant mass and the mass of dried medium is then determined. Water holding capacity (WHC) is then determined according to the formula:—

$$WHC = ( {m}_{1} - {m}_{2} ) \times \frac{100}{Vt}$$

where m₁=mass of drained medium plus container
m₂=mass of dried medium plus container
Vₜ=total volume of mix in millilitres.

Table 2.1 of AS 3743-1996 requires a total water holding capacity:
≦50% for regular seedling mix,
≦40% for regular potting mix, and,
≦50% for premium grade potting mixes.

Of those potting mixes which do comply with the requirements of AS 3743-1996, few if any exceed a total water holding capacity of greater than about 55%. The product of the process described in International Publication WO 95/03371 shows a maximum total water holding capacity of about 50% to 52% whereas the regular potting mix product according to the present invention shows a maximum total water holding capacity up to about 58%.

Surprisingly, the peat alternative product according to the invention shows a total water holding capacity of up to 86%, about 50% greater than prior art products of this type. The superior total water holding capacity of the peat alternative is attributed partially to a smaller particle size distribution but predominantly to a partial loosening or “teasing” of the cellulosic fibres in the particulate product. It is considered that the “teased” fibrous mass in the particles permits enhanced absorption of water in the cellulosic material as well as adsorption on the increased surface area of the teased fibres.

The vastly improved total water holding capacity of plant growth media according to the invention permits less watering of plants, greater retention (or conversely, less leaching) of soluble plant nutrients and otherwise provides a more stable environment to encourage plant growth.

It readily will be apparent to a person skilled in the art that the method and apparatus of the present invention may be modified or varied without departing from the spirit and scope of the invention.

For example, in the treatment/sterilization of peat harvested from the field, the nature of insect, parasite and microbial infestations will vary from one harvesting site to another, and moreover, the intended end use of the peat will largely dictate the manner and extent of its treatment. In some cases the treatment water may contain an insecticide or parasiticide where mere exposure of the peat to water at elevated temperature is inadequate to kill insects or parasites of various species. Similarly, the residence time in the apparatus may be varied as required.

In order to accommodate a longer residence time of material in the apparatus according to the invention, the pitch of the screw auger may be reduced and/or the rate of rotation of the screw auger may be reduced. Alternatively, the length of the auger barrel may be increased.

Where a lengthened auger barrel is employed, at least that portion of the barrel extending beyond the level of water in the barrel portion of the conveyor may be heated by electric elements, steam or oil jackets or the like to maintain a heat input into material passing through the conveyor for continued treatment/sterilization at elevated temperatures and/or to assist in the dewatering of the treated product. If required, the dewatering apertures may extend over the extended barrel portion whereby the material being treated can be extensively dewatered or partially dried by the combination of compressive forces and heat. For some materials such as plant growth media, the use of an extended heated conveyor barrel may permit the material issuing from the outlet port to be bagged either directly or after cooling.

In the case of spent mushroom compost, this may be treated directly without submergence under a body of heated water in the conveyor.

Similarly, freshly harvested peat may be treated directly by passing the material through the heated conveyor without submergence in a body of water therein by adjusting the moisture content of the feed material to a desired level and then relying on heating of the moist material and/or generation of steam therein by heat externally applied to the conveyor barrel.

Spent mushroom compost typically comprises an imported peat product. By sterilizing the spent product and adding nutrients as required, the mushroom compost can be recycled with considerable cost savings.

It is also considered that the apparatus may be suitable for treatment of animal bone and tissue meals intended for use as an animal foodstuff to prevent or at least minimize the risk of disease transmission.

Vegetable waste sourced from municipal waste receiving stations, food processors and retail outlets can also be processed according to the apparatus and process of the invention to produce an animal feed supplement, plant growth medium or the like, either on its own or in combination with other particulate animal feedstuffs or plant growth media respectively.

The treated product, whether of animal or vegetable origin, is resistant to decay and putrefaction and otherwise constitutes a value added product.

Depending upon the nature of the material to be sterilized and/or dried, it may be possible to heat the material in the conveyor barrel to temperatures in excess of 110° C. by the use of a jacketed barrel having heated oil circulating therethrough.

In addition, the auger shaft may comprise a hollow tube through which a heating medium may be circulated. By employing a relatively large length:diameter ratio in the conveyor barrel and/or a relatively large diameter auger shaft, material passing through the auger can be subjected to a very extensive heating and/or drying treatment without compromising throughput efficiency.

In the production of regular grade or premium grade plant growth media products according to Australian Standard AS 3743-1996 or to some other Standard, there may exist a need to distinguish differing grades of material, particularly when the product is supplied in bulk for subsequent packaging. For aesthetic reasons or for permitting instant visual recognition of a grade or type of plant growth medium, a colorant such as an inorganic pigment or an organic dyestuff may be added to the feed stream for the treatment conveyor at a rate of about 1.5 Kg/m³ whereby the colorant is deeply and permanently incorporated into the particulate material during treatment. Typically, the colorants chosen may comprise benign metal oxide pigments of the type employed to colour concrete or cementitious grouts or otherwise organic dyestuffs which do not decompose rapidly and which otherwise do not affect pH toxicity to plants or other properties required to meet Australian Standard AS 3743-1996.

Throughout this specification unless the context requires otherwise, the word “comprise”, and variations such as “comprises” or “comprising” will be understood to imply the inclusion of a stated integer or group of integers or steps but not the exclusion of any other integer or group of integers.

1. A method for production of organic plant growth media from sawmill waste, said process comprising the steps of:—
introducing comminuted sawmill waste into an inlet of a conveyor mechanism containing a body of heated water including a chemical treatment composition selected from a pH modifier, plant nutrients, pesticides, herbicides, microbicides, parasiticides, fungicides or any combination thereof;
submerging said sawmill waste in said body of heated water for a predetermined period of time to kill microorganisms, insects, plant and animal parasites and the like whilst transporting said treated sawmill waste towards an outlet of said conveyor mechanism; and
at least partially dewatering said treated sawmill waste to a predetermined moisture content.

2. A method as claimed in claim 1 wherein said comminuted sawmill waste comprises material of sawmill waste including sawdust, bark and woodchips alone or mixed with up to 20% ww of peat, spent mushroom compost, animal or chicken manure, sewerage sludge, waste vegetables or vegetable scraps, meat or bone meal of animal origin or the like or selected combinations thereof.

3. A method as claimed in claim 2 wherein said sawmill waste comprises particulate pine bark having a layer of exogenous bark adhering to endogenous bark said method further including the step of at least partially separating said endogenous bark and said exogenous bark.

4. A method as claimed in claim 3 wherein at least partial separation of said exogenous bark and said endogenous bark is effected in said conveyor system by the application of mechanical shear forces to said particulate pine bark.

5. A method as claimed in claim 3 wherein at least partial separation of said exogenous bark and said endogenous bark is effected during or subsequent to the step of at least partial dewatering of said sawmill waste.

6. A method as claimed in claim 1 wherein said body of water is heated to a temperature in the range 85° to 125° C.

7. A method as claimed in claim 6 wherein said body of water is heated to a temperature in the range 100° TO 110° C.

8. A method as claimed in claim 1 wherein said sawmill waste suitably is comminuted to a particle size where substantially all said comminuted sawmill waste passes through a 12 mm screen.

9. A method as claimed in claim 1 wherein said treated sawmill waste is at least partially dewatered in said conveyor mechanism adjacent an outlet port thereof.

10. A method as claimed in claim 1 wherein said treated sawmill waste is at least partially dewatered under the influence of mechanical pressure.

11. A method as claimed in claim 1 wherein said treated sawmill waste is at least partially dewatered in a rotary dewatering apparatus.

12. A method as claimed in claim 3 wherein said treated sawmill at least partially dewatered treated sawmill waste containing at least partially separated exogenous bark and endogenous bark is subjected to mechanical shear under pressure to loosen fibrous bonds in said at least partially dewatered treated sawmill waste to enhance moisture retention therein.

13. An apparatus for manufacture of organic plant growth media from sawmill waste, said apparatus comprising:—
a conveyor in the form of a screw auger rotatably housed in a tubular body, said conveyor being inclined with an inlet port located at a lower end of said tubular body and an outlet port at an upper end of said tubular body;
a drive mechanism for said screw auger;
a heating device to heat a body of water located, in use, in said tubular body; and,
a dewatering station located adjacent said outlet port, said dewatering station, in use, at least partially dewatering treated sawmill waste in said tubular body.

14. An apparatus as claimed in claim 13 wherein said inlet port comprises an upright tubular member in fluid communication with said lower end of said tubular body.

15. An apparatus as claimed in claim 14 wherein said inlet port, in use, accommodates portion of a body of water located within said conveyor with an upper surface of said portion being located above a feed end of said screw auger to form a liquid seal between said inlet port and a bore of said tubular body.

16. An apparatus as claimed in claim 15 wherein said inlet port includes a feed mechanism to assist in directing buoyant feed material towards said feed end of said screw auger.

17. An apparatus as claimed in claim 14 including a metering device to meter water into said conveyor.

18. An apparatus as claimed in claim 13 including one or more metering devices to deliver one or more chemical treatment compositions to said inlet port.

19. An apparatus as claimed in claim 13 wherein said heating device is located adjacent said lower end of said tubular body.

20. An apparatus as claimed in claim 13 wherein said heating device comprises a steam generator fluidically coupled adjacent a lower end of said tubular body.

21. An apparatus as claimed in claim 13 wherein said dewatering station comprises a region of tubular body having a plurality of apertures therein through which to drain water from said treated sawmill waste.

22. An apparatus as claimed in claim 21, wherein the dewatering station is adapted to apply a compressive force to treated sawmill waste contained therein.

23. An apparatus as claimed in claim 22 wherein said dewatering station comprises a region of said screw auger wherein the pitch of said auger is reduced to cause, in use, compression of said treated sawmill waste to assist in dewatering thereof.

24. An apparatus as claimed in claim 22 wherein said dewatering station comprises a region of said conveyor where respective diameters of said screw auger and an adjacent region of said tubular body are reduced to cause, in use, compression of said treated sawmill waste to assist in dewatering thereof.

25. An apparatus as claimed in claim 13 wherein said dewatering station additionally comprises a rotatable screen or the like.

26. An apparatus as claimed in claim 13 including a shredding device to subject fibrous materials in at least-partially dewatered organic media to mechanical shear under pressure to loosen fibrous bonds in said at least partially dewatered treated sawmill waste to enhance moisture retention therein.

27. An organic plant growth medium whenever produced in accordance with the method of any one of claims 1 to 12.

28. An organic plant growth medium according to claim 27 incorporating a colorant denoting properties of said growth medium.

29. A method of producing an organic plant growth medium with the apparatus of any one of claims 13 to 26.

30. An organic plant growth medium whenever produced by the apparatus of any one of claims 13 to 26.

31. A shredder for use in accordance with the method of claim 12, said shredder adapted in use to force at least partially dewatered treated sawmill waste through a screen by application of a mechanical shear force to said treated sawmill waste.
